(19) United States
(12) Patent Application Publication
(10) Pub. No.: US 2016/0227267 A1
(43) Pub. Date: Aug. 4, 2016

(54) METHOD AND SYSTEM FOR VIEWING SET TOP BOX CONTENT IN A VIRTUAL REALITY DEVICE

(71) Applicant: THE DIRECTV GROUP, INC., El Segundo, CA (US)

(72) Inventors: Brady C. Tsurutani, Los Angeles, CA (US); Kenneth H. Lee, Rancho Palos Verdes, CA (US); David Iverson, Placentia, CA (US)

(73) Assignee: THE DIRECTV GROUP, INC., El Segundo, CA (US)

(21) Appl. No.: 14/610,899

(22) Filed: Jan. 30, 2015

(51) Int. Cl. H04N 21/426; H04N 21/414; H04N 21/431; H04N 21/4402; H04N 21/4363; H04N 21/643; H04N 21/61; H04N 21/81; H04N 21/222; H04N 21/436; H04N 21/41; H04N 21/485

(52) U.S. Cl. CPC H04N 21/42653; H04N 21/4122; H04N 21/4126; H04N 21/41407; H04N 21/42607; H04N 21/4312; H04N 21/440272; H04N 21/4858; H04N 21/64322; H04N 21/6143; H04N 21/8146; H04N 21/2221; H04N 21/43615; H04N 21/43637

(57) ABSTRACT

A system and method includes a user receiving device receiving a linear content signal from a head end and a client device in communication with the user receiving device. The user receiving device generates renderable signal from the live linear content and communicates the linear content signal or renderable signal to the client device as a display signal. The client device comprises a virtual reality application defining a television display area for a graphics display of a virtual reality display device. The virtual reality application scales the linear content signal or the renderable signal to correspond to the television display area to form scaled content. The virtual reality display device displays virtual reality graphics with the scaled content in the television display area.

### TECHNICAL FIELD

The present disclosure relates generally to communicating between a server device and a client device, and, more specifically, to control content live viewing using a virtual reality device.

### BACKGROUND

The statements in this section merely provide background information related to the present disclosure and may not constitute prior art.

Satellite television has become increasingly popular due to the wide variety of content and the quality of content available. A satellite television system typically includes a set top box that is used to receive the satellite signals and decode the satellite signals for use on a television.

Satellite television systems typically broadcast content to a number of users simultaneously in a system. Satellite television systems also offer subscription or pay-per-view access to broadcast content. Access is provided using signals broadcast over the satellite. Once access is provided, the user can access the particular content.

Many content providers are offering systems that provide a centralized server with a large video storage device therein. Multiple clients are connected to the server to allow video content to be displayed at a display device associated with the server.

Virtual reality devices are gaining in popularity particularly for gaming systems. Virtual reality devices offer a user interface that changes the display as the user moves.

### SUMMARY

The present disclosure provides a method and system for displaying a live content with a virtual reality device.

In one aspect of the disclosure, a method includes communicating live linear content to a user receiving device, generating a live linear content renderable signal at the user receiving device from the live linear content, communicating the live linear content renderable signal to a client device, defining a live linear content display area for a graphics display of a virtual reality display device within a virtual reality application, scaling the live linear content renderable signal to correspond to the live linear content display area within the virtual reality application to form scaled live content and displaying the virtual reality graphics with the scaled live content in the live content area.

In a further aspect of the disclosure, a system includes a system and method that includes a user receiving device receiving a linear content signal from a head end and a client device in communication with the user receiving device. The user receiving device generates renderable signal from the live linear content and communicates the linear content signal or renderable signal to the client device as a display signal. The client device comprises a virtual reality application defining a television display area for a graphics display of a virtual reality display device. The virtual reality application scales the linear content signal or the renderable signal to correspond to the television display area to form scaled content. The virtual reality display device displays virtual reality graphics with the scaled content in the television display area.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a high level block diagrammatic view of a satellite distribution system according to the present disclosure.

FIG. 2 is a block diagrammatic view of a user receiving device according to one example of the present disclosure.

FIG. 3 is a block diagram of a head end according to one example of the present disclosure.

FIG. 4 is a block diagram of a client device according one example of the present disclosure.

FIG. 5 is a block diagram of a wearable device according to one example of the present disclosure.

FIG. 6 is a perspective view of a virtual reality device on a user relative to the sensed motions.

FIG. 7 is a block diagrammatic view of the virtual reality application of FIG. 4.

FIG. 8 is a screen display of a virtual reality device having a relatively small live television signal display area.

FIG. 9 is a screen display of a virtual reality device having a relatively larger screen compared to that of FIG. 8.

FIG. 10 is a screen display of a virtual reality device having a full screen for displaying the live television signals.

FIG. 11 is a flowchart of a method for controlling a virtual reality device.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical OR. It should be understood that steps within a method may be executed in different order without altering the principles of the present disclosure.

The teachings of the present disclosure can be implemented in a system for communicating content to an end user or user device. Both the data source and the user device may be formed using a general computing device having a memory or other data storage for incoming and outgoing data. The memory may comprise but is not limited to a hard drive, FLASH, RAM, PROM, EEPROM, ROM phase-change memory or other discrete memory components.

Each general purpose computing device may be implemented in analog circuitry, digital circuitry or combinations thereof. Further, the computing device may include a microprocessor or microcontroller that performs instructions to carry out the steps performed by the various system components.

A content or service provider is also described. A content or service provider is a provider of data to the end user. The service provider, for example, may provide data corresponding to the content such as metadata as well as the actual content in a data stream or signal. The content or service provider may include a general purpose computing device, communication components, network interfaces and other associated circuitry to allow communication with various other devices in the system.

Further, while the following disclosure is made with respect to the delivery of video (e.g., television (TV), movies, music videos, etc.), it should be understood that the systems and methods disclosed herein could also be used for delivery of any media content type, for example, audio, music, data files, web pages, advertising, etc. Additionally, throughout this disclosure reference is made to data, content, information, programs, movie trailers, movies, advertising, assets, video data, etc., however, it will be readily apparent to persons of ordinary skill in the art that these terms are substantially equivalent in reference to the example systems and/or methods disclosed herein. As used herein, the term title will be used to refer to, for example, a movie itself and not the name of the movie. While the following disclosure is made with respect to example DIRECTV® broadcast services and systems, it should be understood that many other delivery systems are readily applicable to disclosed systems and methods. Such systems include wireless terrestrial distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), Internet-based distribution systems, cellular distribution systems, power-line broadcast systems, any point-to-point and/or multicast Internet Protocol (IP) delivery network, and fiber optic networks. Further, the different functions collectively allocated among a service provider and integrated receiver/decoders (IRDS) as described below can be reallocated as desired without departing from the intended scope of the present patent.

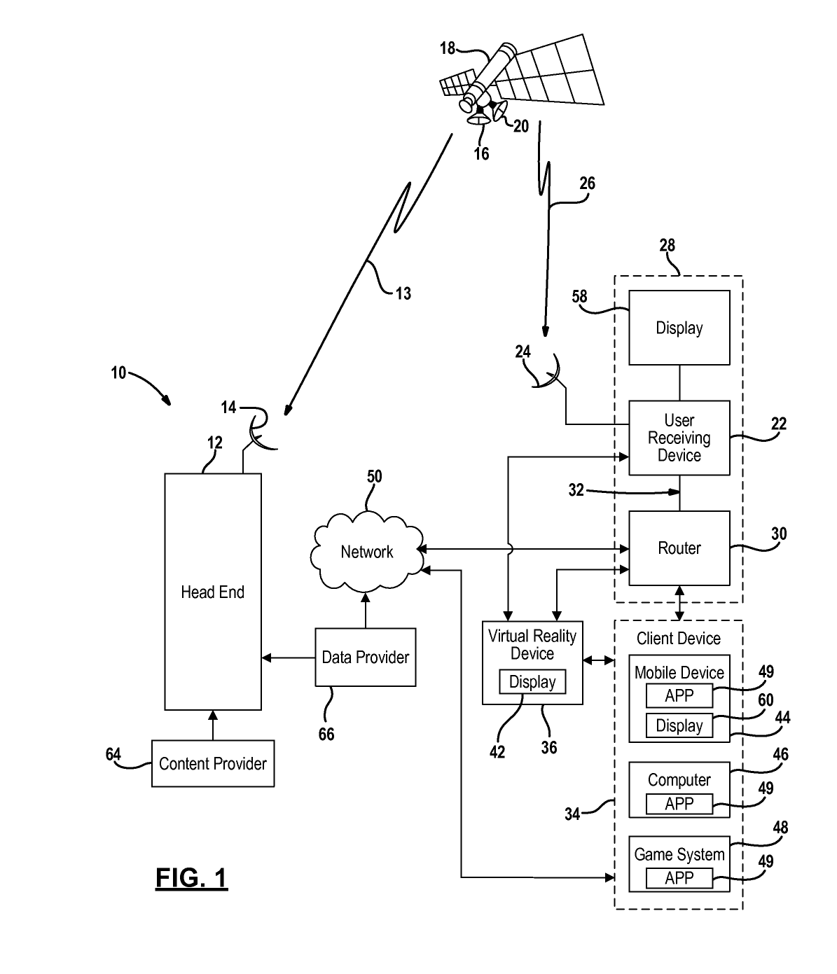

Referring now to FIG. 1, a satellite television broadcasting system 10 is illustrated. The satellite television broadcast system 10 includes a head end 12 that generates wireless signals 13 through an antenna 14 which are received by an antenna 16 of a satellite 18. The wireless signals 13, for example, may be digital. The wireless signals 13 may be referred to as an uplink signal. A transmitting antenna 20 generates downlink signals 26 that are directed to a user receiving device 22. The user receiving device 22 may be located within a building 28 such as a home, multi-unit dwelling or business. The user receiving device 22 is in communication with an antenna 24. The antenna 24 receives downlink signals 26 from the transmitting antenna 20 of the satellite 18. Thus, the user receiving device 22 may be referred to as a satellite television receiving device. However, the system has applicability in non-satellite applications such as a wired or wireless terrestrial system. Therefore the user receiving device 22 may be referred to as a television receiving device or set top box. More than one user receiving device 22 may be included within a system or within a building 28. The user receiving devices 22 may be interconnected.

The downlink signals 26 that are communicated to the antenna 24 may be live linear television signals. Live television signals may be referred to as linear content because they are broadcasted at a predetermined time on a predetermined channel. A grid guide commonly includes linear content arranged by channel and by time. The linear content is different than on-demand content that is communicated from the head end or other content distribution network to a user receiving device 22 when requested by the user. The client device 34 may also be in direct communication with the virtual reality device 36. That is, the client device 34 may act as a display 42 for the client device 34. The virtual reality device 36 may also act as an input to the client device 34. The operation of the client device 34 relative to the virtual reality device 36 will be described in detail below.

The client device 34 may comprise many different types of devices. One or more client devices may be used in a system. In this example, the client device 34 includes a mobile device 44, a computer 46 and a game system 48. Each of the devices may include an application (App) 49 that is used for interfacing with the virtual reality device 36. The application 49 may be a game or other type of computer program that displays content on the display 42 of the virtual reality device 36. As mentioned above, one or more client devices 34 may be provided in any system. The mobile device 44 may be a mobile phone, tablet computer, laptop computer, or other type of mobile computing device. The computer 46 may be a desk top computer. The game system 48 may operate various types of games that use virtual reality device 36 as an input and as display.

The user receiving device 22 may be in communications with a router 30 that forms a local area network 32 with a client device 34 and/or a virtual reality device 36. The router 30 may be a wireless router or a wired router or a combination of the two. For example, the user receiving device 22 may be wired to the router 30 and wirelessly coupled to the client device 34 and to the virtual reality device 36. The router 30 may communicate internet protocol (IP) format signals to the user receiving device 22. The IP signals may be used for controlling various functions of the user receiving device 22. IP signals may also originate from the user receiving device 22 for communication to other devices such as the client device 34 or the virtual reality device 36 through the router 30. The client device 34 and the virtual reality device 36 may also communicate signals to the user receiving device 22 through the router 30.

The virtual reality device 36 may be wearable on a user meaning it is meant to be fixed to the user during operation. An example of a virtual reality device 36 includes an Oculus VR®. The complexity of the virtual reality device 36 may vary from a simple display device with motion sensor to a device having various inputs and user interfaces. The virtual reality device 36 may be in direct communication with the user receiving device 22 and/or the client device 34 through a Bluetooth® connection. The virtual reality device 36 may also be in communication with the user receiving device 22 and the client device 34 through an IP connection through the router 30 and a local area network. The virtual reality device 36 may also be in communication with devices outside the local area network 32 through the router 30. That is, the virtual reality device 36 may communicate with other devices such as the head end 12 through the network 50. The virtual reality device 36 may also be in communication with the client device 34 which provides a bridge or a communication path to the router 30 and ultimately to the user receiving device 22 or the network 50. The virtual reality device 36 may generate signals such as selection signals that are communicated through the client device 34 but are destined to be used by the user receiving device 22, the head end 12 or other user devices in communication with the network 50.

The client device 34 may also be in communication with the router 30, the head end 12 and various other devices through the network 50 or other devices in other parts of the network 50.

The user receiving device 22 includes a screen display 58 associated therewith. The display 58 may be a television or other type of monitor. The display 58 may display both video signals and audio signals.

The client device 34 may also have a display 60 associated therewith. The display 60 may also display video and audio signals. The display 60 may be integrated into the client device 34. The display 60 may also be a touch screen that acts as at least one user interface. Other types of user interfaces on the client devices may include buttons and switches.

The display 42 of the virtual reality device 36 may also display video and audio signals. The display 42 may be integrated into the virtual reality device 36. The display 42 may be a stereoscopic display that displays slightly different image for each eye of the user. The display 42 is combined in the brain of the user to form a continuous image. A projected display or user interface may also be projected on the display 42. The virtual reality device 36 may also contain physical function selectors, switches, or buttons as other types of user interfaces.

The user receiving device 22 may be in communication with the head end 12 through the external network or simply, network 50. The network 50 may be one type of network or multiple types of networks. The network 50 may, for example, be a public switched telephone network, the internet, a mobile telephone network or other type of network. The network 50 may be in communication with the user receiving device 22 through the router 30. The network 50 may also be in communication with the client device 34 through the router 30. Of course, the network 50 may be in direct communication with the client device 34 or virtual reality device 36 such as in a cellular system.

The system 10 may also include a content provider 64 that provides content to the head end 12. Although only one content provider 64 is illustrated, more than one content provider may be used. The head end 12 is used for distributing the content through the satellite 18 or the network 50 to the user receiving device 22, client device 34, or the virtual reality device 36.

A data provider 66 may also provide data to the head end 12. The data provider 66 may provide various types of data such as schedule data or metadata. The metadata may ultimately be provided to a user device through the program guide system. The metadata may include various descriptions, actor, director, star ratings, titles, user ratings, television or motion picture parental guidance ratings, descriptions, related descriptions and various other types of data. The data provider 66 may provide the data directly to the head end 12 and may also provide data to various devices such as the client device 34, virtual reality device 36, mobile device 44 and the user receiving device 22 through the network 50, or through the user receiving device 22, as connected through router 30. This may be performed in a direct manner through the network 50, or indirectly such as through the user receiving device 22.

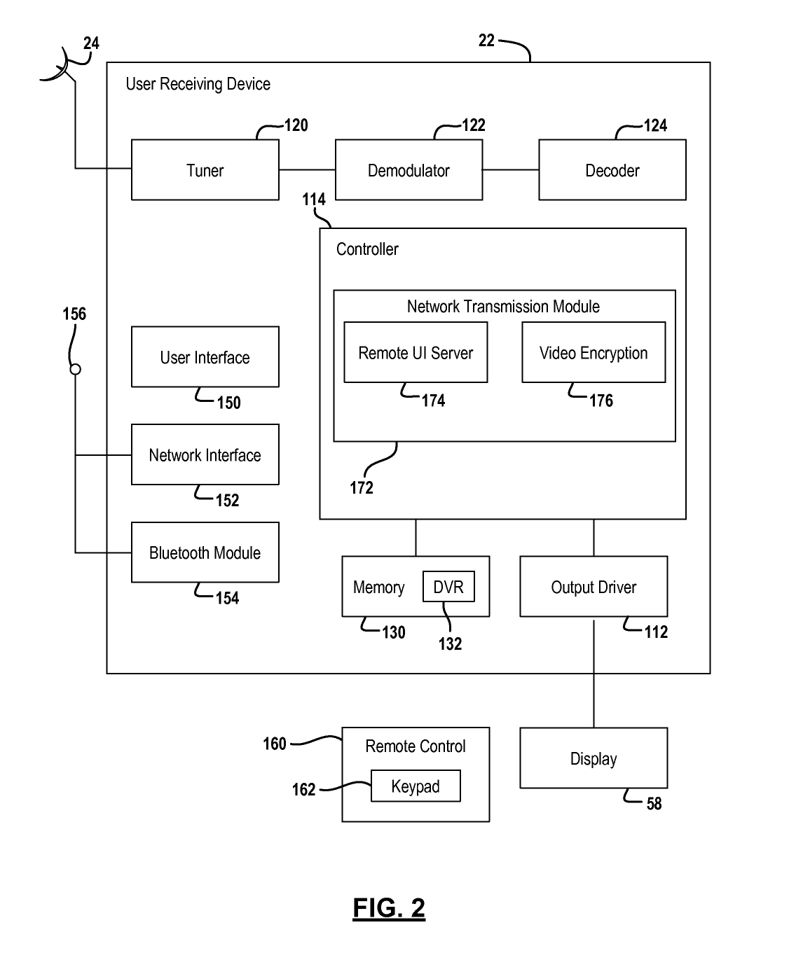

Referring now to FIG. 2, a user receiving device 22, such as a set top box is illustrated in further detail. Although, a particular configuration of the user receiving device 22 is illustrated, it is merely representative of various electronic devices with an internal controller used as a content receiving device. Each of the components illustrated may be capable of communicating therebetween even though a physical line is not drawn.

The antenna 24 may be one of a number of different types of antennas that includes one or more low noise blocks. The antenna 24 may be a single antenna 24 used for satellite television reception. The user receiving device 22 is in communication with the display 58. The display 58 may have an output driver 112 within the user receiving device 22.

A controller 114 may be a general processor such as a microprocessor that cooperates with control software. The controller 114 may be used to coordinate and control the various functions of the user receiving device 22. These functions may include a tuner 120, a demodulator 122, a decoder 124 such as a forward error correction decoder, a buffer or other functions.

The tuner 120 receives the signal or data from the individual satellite channel or channel bonding. The tuner 120 may receive television programming content, program guide data or other types of data. The demodulator 122 demodulates the signal or data to form a demodulated signal or data. The decoder 124 decodes the demodulated signal to form decoded data or a decoded signal. The controller 114 may be similar to that found in current DIRECTV® set top boxes which uses a chip-based multifunctional controller. Although only one tuner 120, one demodulator 122 and one decoder 124 are illustrated, multiple tuners, demodulators and decoders may be provided within a single user receiving device 22.

The controller 114 is in communication with a memory 130. The memory 130 is illustrated as a single box with multiple boxes therein. The memory 130 may actually be a plurality of different types of memory including the hard drive, a flash drive and various other types of memory. The different boxes represented in the memory 130 may be other types of memory or sections of different types of memory. The memory 130 may be non-volatile memory or volatile memory.

The memory 130 may include storage for content data and various operational data collected during operation of the user receiving device 22. The memory 130 may also include advanced program guide (APG) data. The program guide data may include various amounts of data including two or more weeks of program guide data. The program guide data may be communicated in various manners including through the satellite 18 of FIG. 1. The program guide data may include a content or program identifiers, and various data objects corresponding thereto. The program guide may include program characteristics for each program content. The program characteristic may include ratings, categories, actor, director, writer, content identifier and producer data. The data may also include various user profiles such as other settings like parental controls.

The memory 130 may also store a user receiving device identifier that uniquely identifies the user receiving device 22. The user receiving device identifier may be used in communications through the network to address commands thereto.

The memory 130 may also include a digital video recorder. The digital video recorder 132 may be a hard drive, flash drive, or other memory device. A record of the content stored in the digital video recorder 132 is a playlist. The playlist may be stored in the DVR 132 or a separate memory as illustrated.

The user receiving device 22 may also include a user interface 150. The user interface 150 may be various types or combinations of various types of user interfaces such as but not limited to a keyboard, push buttons, a touch screen or a remote control. The user interface 150 may be used to select a channel, select various information, change the volume, change the display appearance, or other functions. The user interface 150 may be used for generating a selection signal for selecting content or data on the display 58.

A network interface 152 may be included within the user receiving device 22 to communicate various data through the network 50 illustrated above. The network interface 152 may be a WiFi, WiMax, WiMax mobile, wireless, cellular, or other types of communication systems. The network interface 152 may use various protocols for communication therethrough including, but not limited to, hypertext transfer protocol (HTTP).

A Bluetooth® module 154 may send and receive Bluetooth® formatted signals to or from the client device or virtual reality device.

Both the Bluetooth® module 154 and the network interface 152 may be connected to one or more wireless antennas 156. The antenna 156 generates RF signals that may correspond to a user receiving device identifier.

A remote control device 160 may be used as a user interface for communicating control signals to the user receiving device 22. The remote control device may include a keypad 162 for generating key signals that are communicated to the user receiving device 22.

The controller 114 may also include a network transmission module 172. The network transmission module 172 may be used to generate and communicate signals that are renderable such as the program guide, playlist and other menus and also communicate the output of the decoder 124. The signals that are formed by the network transmission module 172 may include both audio signals and video signals. One suitable transmission format for live signals to a client is a digital transmission content protection over Internet protocol (DTCP-IP). The user receiving device may communicate securely with the client using the DTCP-IP signals. A video encryption module 176 may encrypt the video signal and audio signal communication from the user receiving device 22 and the client using the DTCP-IP format. A remote interface server module 174 may be used for communicating the program guide, banners, playlists and other renderable signals without the need for encryption. By providing renderable signals, the client device may be a relatively simple device that may be easily implemented in a variety of different types of electronic devices such as a computer, a thin client, a gaming module and directly incorporated into televisions. The processing involved at the client device will thus be reduced and will therefore by less expensive.

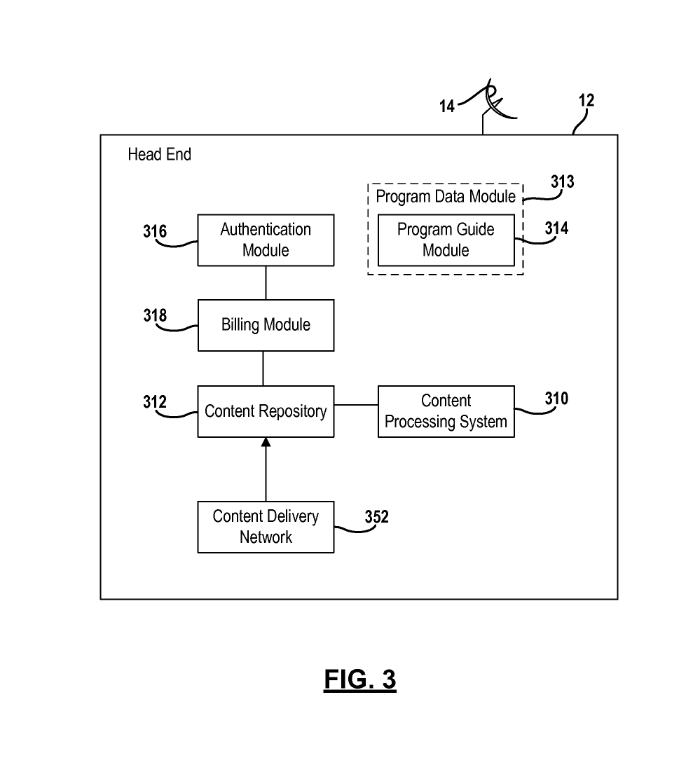

Referring now to FIG. 3, the head end 12 is illustrated in further detail. The head end 12 may include various modules for intercommunicating with the client device 34 and the user receiving device 22 as illustrated in FIG. 1. Only a limited number of interconnections of the modules are illustrated in the head end 12 for drawing simplicity. Other interconnections may, of course, be present in a constructed example. The head end 12 receives content from the content provider 64 illustrated in FIG. 1. A content processing system 310 processes the content for communication through the satellite 18. The content processing system 310 may communicate live content as well as recorded content both as linear content (at a predetermined time and on a corresponding channel). The content processing system 310 may be coupled to a content repository 312 for storing content therein. The content repository 312 may store and process On-Demand or Pay-Per-View content for distribution at various times. The virtual reality device may also display on-demand content. The Pay-Per-View content may be broadcasted in a linear fashion (at a predetermined time according to a predetermined schedule). Linear content is presently broadcasting and may also be scheduled in the future. The content repository 312 may also store On-Demand content therein. On-Demand content is content that is broadcasted at the request of a user receiving device and may occur at any time (not on a predetermined schedule). On-Demand content is referred to as non-linear content.

The head end 12 also includes a program data module 313 that may include various types of data related to programming past, present and future. A program guide module 314 may also be included in the program data module 313. The program guide module 314 may include the programming data for present and future program data. The program guide module 314 communicates program guide data to the user receiving device 22 illustrated in FIG. 1. The program guide module 314 may create various objects that are communicated with various types of data therein. The program guide module 314 may, for example, include schedule data, various types of descriptions for the content and content identifier that uniquely identifies each content item. The program guide module 314, in a typical system, communicates up to two weeks of advanced guide data for linear content to the user receiving devices. The guide data includes tuning data such as time of broadcast, end time, channel, and transponder to name a few. Guide data may also include content available on-demand and pay-per-view content

An authentication module 316 may be used to authenticate various user receiving devices, client devices and virtual reality devices that communicate with the head end 12. Each user receiving device, client device and virtual reality device may have a unique identifier. The user identifiers may be assigned at the head end or associated with a user account at the head end. The authentication module 316 may be in communication with a billing module 318. The billing module 318 may provide data as to subscriptions and various authorizations suitable for the user receiving devices, the client devices and virtual reality devices that interact with the head end 12. The authentication module 316 ultimately permits the user receiving devices and client devices to communicate with the head end 12. Authentication may be performed by providing a user identifier, a password, a user device identifier or combinations thereof.

A content delivery network 352 may be in communication with a content repository 312. The content delivery network 352 is illustrated outside of the head end 12. However, the content delivery network 352 may also be included within the head end 12. The content delivery network 352 may be managed or operated by operators other than the operators of the head end 12. The content delivery network 352 may be responsible for communicating content to the various devices outside of the head end 12. Although only one content delivery network 352 is illustrated, multiple content delivery networks may be used.

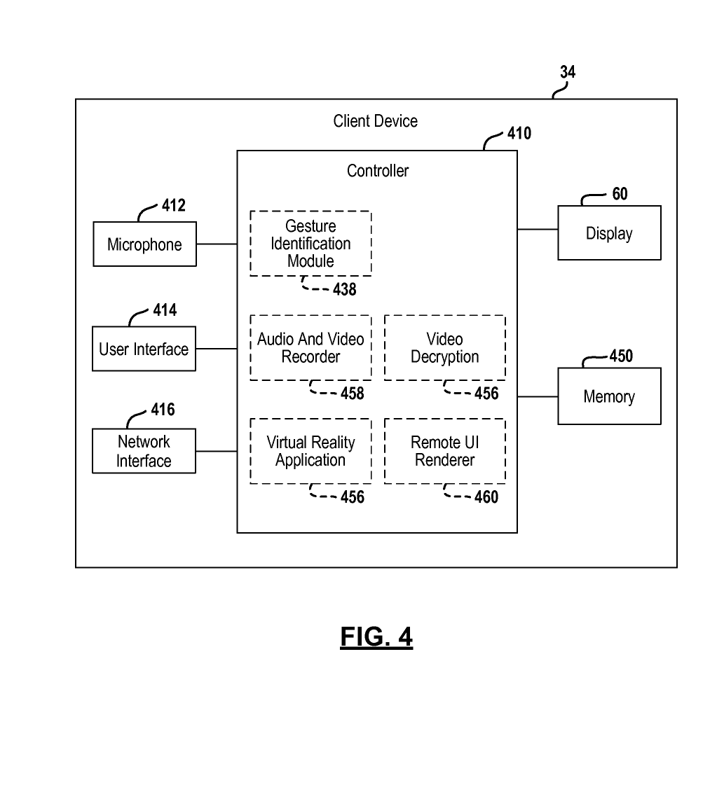

Referring now to FIG. 4, the client device 34 is illustrated in further detail. In this example the client device is the mobile device 44. However other types of client devices may be configured similarly. The client device 34 includes a controller 410 that includes various modules that control the various functions.

The controller 410 is in communication with a microphone 412 that receives audible signals and converts the audible signals into electrical signals. The audible signals may include a request signal. The request signal may be to perform a search, obtain guide data, network data or playlist data.

The controller 410 is also in communication with a user interface 414. The user interface 414 may be buttons, input switches or a touch screen.

A network interface 416 is also in communication with the controller 410. The network interface 416 may be used to interface with the network 50. As mentioned above, the network 50 may be a wireless network or the internet. The network interface 416 may communicate with a cellular system or with the internet or both. A network identifier may be attached to or associated with each communication from the client device so that a determination may be made by another device as to whether the client device and the user receiving device are in the same local area network.

The controller 410 may also be in communication with the display 60 described above in FIG. 1. The controller 410 may generate graphical user interfaces and content descriptions.

The controller 410 may also include a gesture identification module 438 that identifies gestures performed on the display 60. Gestures may be used as part of a user interface. For example, the gestures may be a move of dragging the user's finger up, down, sideways or holding in a location for a predetermined amount of time. A gesture performed at a certain screen may be translated into a particular control command for making a selection or communicating to the user receiving device.

The client device 34 may also include a virtual reality application 456 within the controller 410. The virtual reality application 456, in general, obtains sensor data and scales live video for display by the virtual reality device within the graphics of the application. That is, a live television display area may be defined within graphics of a program or application. The position and size of the display area may change relative to the virtual reality device. Therefore, the size and position of the live television display within the graphics may be changed. The output of the virtual reality application comprises audio and video signals that are to be displayed at the virtual reality device. This includes the graphics, the television display in the graphics and the scaled video signal to be displayed within the television graphics.

The controller 410 may also include a video decryption module 456 for decrypting the encrypted audio signals and video signals content received from the user receiving device to form decrypted signals. The decryption module 456 may decrypt the DTCP-IP formatted signals. An audio and video decoder 458 issued to process the signals for displaying the audio and video signals. A remote user interface renderer 460 renders the non-encrypted signals to form screen display such as the program guide as mentioned above. The video and rendered graphics signals are communicated to the virtual reality application for scaling and display together with the virtual reality graphics.

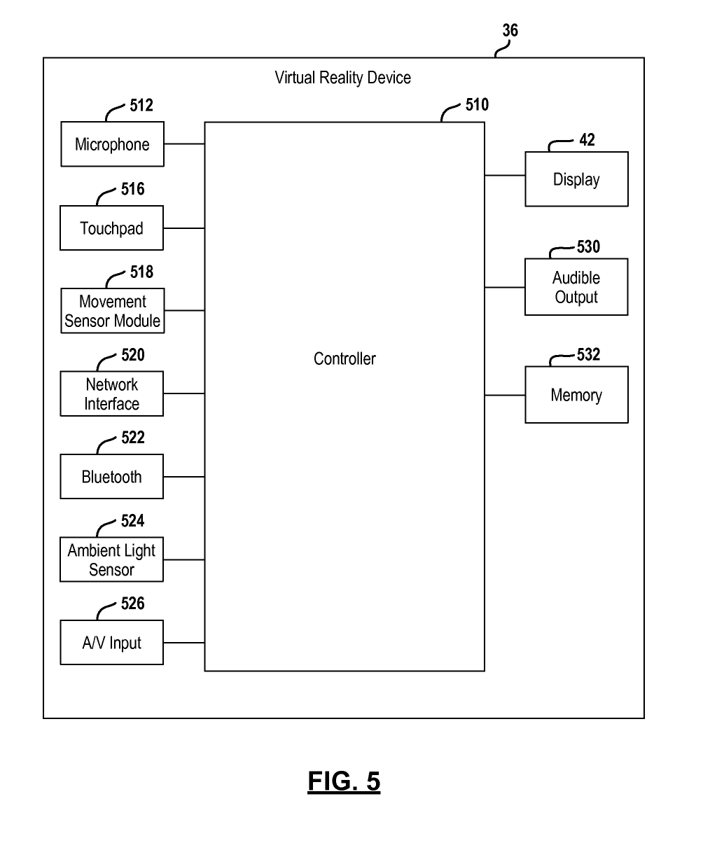

Referring now to FIG. 5, a block diagrammatic view of virtual reality device 36 is set forth. The virtual reality device 36 may include a microphone 512 that receives audible signals and converts the audible signals into electrical signals. A touchpad 516 provides digital signals corresponding to the touch of a hand or finger. The touchpad 516 may sense the movement of a finger or other user input. The virtual reality device 36 may also include a movement sensor module 518 that provides signals corresponding to movement of the device. Physical movement of the device may also correspond to an input. The movement sensor module 518 may include accelerometers and moment sensors that generate signals that allow the device to determine the relative movement and orientation of the device. The movement sensor module 518 may also include a magnetometer.

The virtual reality device 36 may also include a network interface 520. The network interface 520 provides input and output signals to a wireless network, such as the internet. The network interface 520 may also communicate with a cellular system.

A Bluetooth® module 522 may send and receive Bluetooth® formatted signals to and from the controller 510 and communicated them externally to the virtual reality device 36. Bluetooth® may be one way to receive audio signals or video signals from the client device.

An ambient light sensor 524 generates a signal corresponding to the ambient light levels around the virtual reality device 36. The ambient light sensor 524 generates a digital signal that corresponds to the amount of ambient light around the virtual reality device 36 and adjusts the brightness level in response thereto.

An A/V input 526 may receive the audio signals and the video signals from the client device. In particular, the A/V input 526 may be a wired or wireless connection to the virtual reality application of the client device.

The controller 510 may also be in communication with the display 42 an audio output 530 and a memory 532. The audible output 530 may generate an audible signal through a speaker or other device. Beeps and buzzers to provide the user with feedback may be generated. The memory 532 may be used to store various types of information including a user identifier, a user profile, a user location and user preferences. Of course, other operating parameters may also be stored within the memory 532.

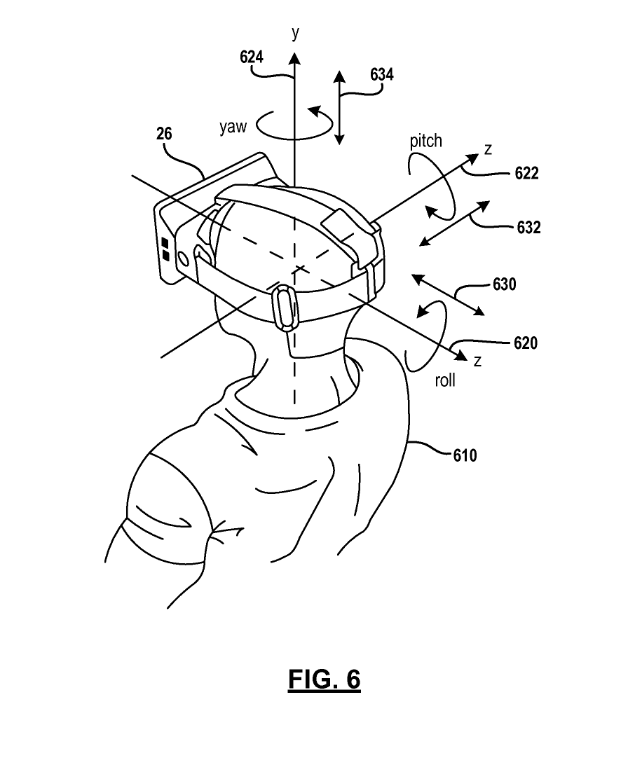

Referring now to FIG. 6, the movement sensors 518 of FIG. 5 may be used to measure various perimeters of movement. A user 610 has the virtual reality device 36 coupled thereto. The moments around a roll axis 620, a pitch axis 622 and a yaw axis 624 are illustrated. Accelerations in the roll direction 630, the pitch direction 632 and the yaw direction 634 are measured by sensors within the virtual reality device 36. The sensors may be incorporated into the movement sensor module 518, the output of which is communicated to the client device 34 for use within the virtual reality application 456.

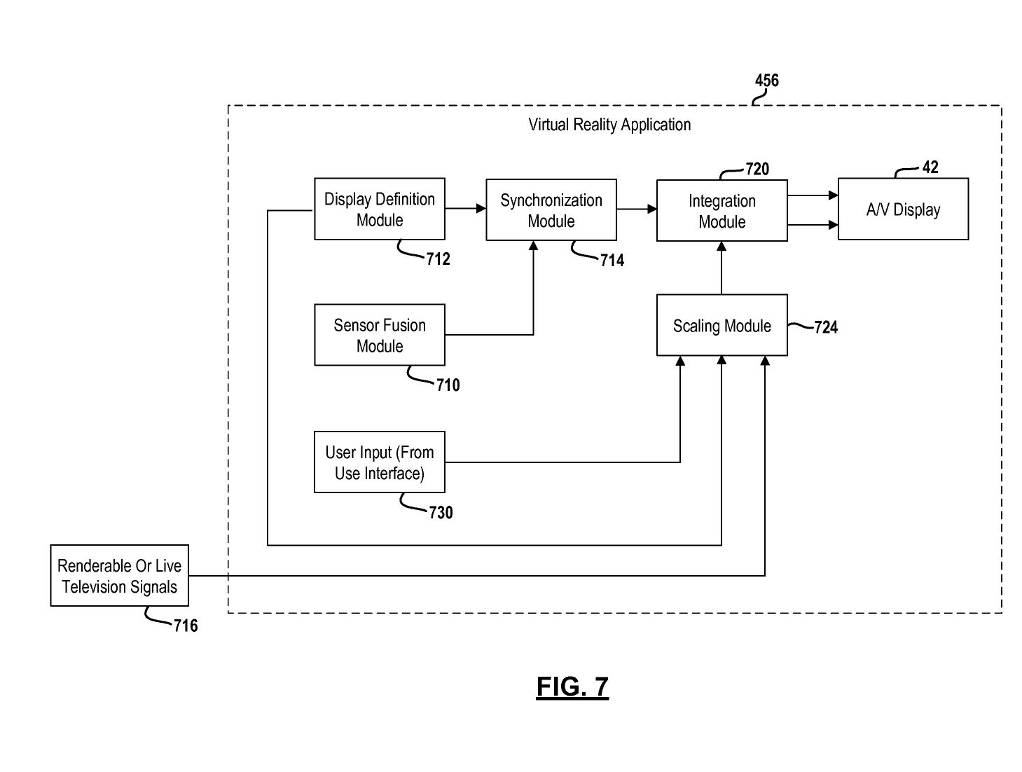

Referring now to FIG. 7, the virtual reality application 456 is illustrated in further detail. The virtual reality application 456 may include a sensor fusion module 710 that receives the sensor signals from the movement sensors 518 of FIG. 5. The sensor fusion module 710 determines the ultimate movement of the virtual reality device 36 so that the display 42 may ultimately be changed accordingly.

The virtual reality application 456 may also include a live definition module 712. The display definition module 712 may define a display area for displaying live signals and/or renderable signals with the displayed graphics of an application or program.

Virtual reality systems move the screen display based upon the position of the head and movement of the head as determined by the sensor fusion modules 710. The movement of the head corresponds directly to the movement of the virtual reality device. The output of the display definition module 712 may be input to a synchronization module 714. The synchronization module 714 coordinates the position of the video display with the output of the sensor fusion module 710. The synchronization module output 714 is communicated to an integration module 720.

The rendering integration module 720 may also receive an output from a scaling module 724. The renderable or live television signals 716 are communicated to the scaling module 724 so that they are properly scaled for the size and perspective of the television display area within the graphics generated by the virtual reality application. The television display area within the graphics moves together with the underlying graphics. The integration module 720 outputs rendered signals corresponding to the application and the live television signals that have been scaled to the display 42.

A user input 730 from a user interface such as game controller or touch screen may also be used to change the screen display. For example, the video may change from the display area graphics to a full screen upon command from the user. A button or voice command signal may be generated to perform this function.

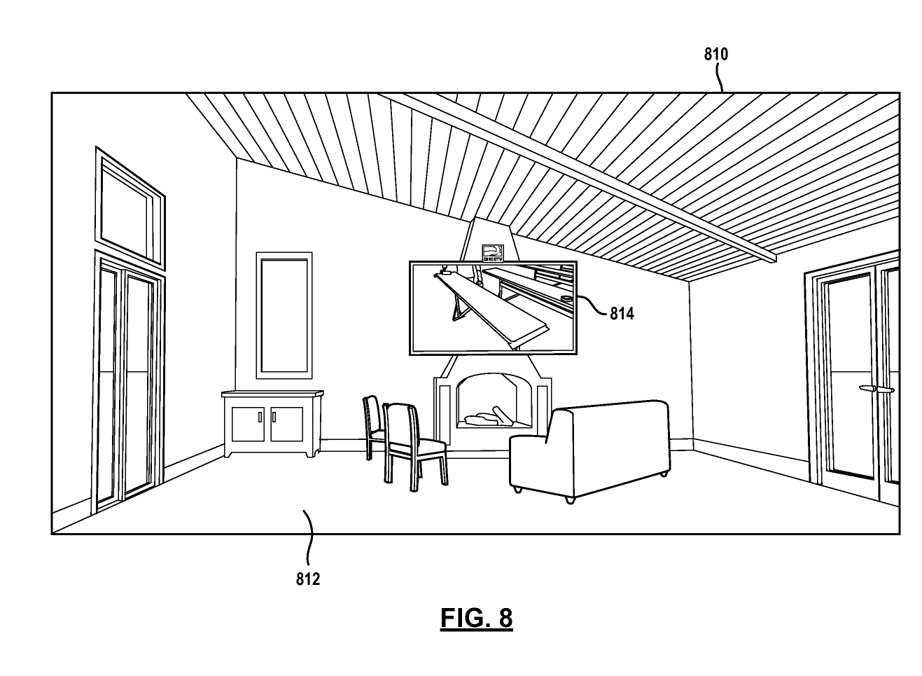

Referring now to FIG. 8, a screen display 810 displaying graphics of a room 812 is illustrated. Upon virtually entering the room 812, a television display area 814 is illustrated displaying live television signals. Renderable signals the television display area remains fixed to the underlying graphics. Should the user turn his head or perform some other movement, the relative position of the television display area 814 within the graphics of the room 812 is maintained relative to the graphics, but the position of the room in the screen display area may change. For example, if the user turns his head to the right, the screen display area 814 may appear more toward the left side of the screen display 810. As mentioned above, the scaling module 724 of FIG. 7 may scale the size of the television display area 814 to the proper dimensions. The scaling module 724 may also scale the perspective of the screen display area 814. That is as the user moves closer and further away the size may change. Also the scaling module 724 may change the screen of the virtual reality device to a full video screen upon the selection through a user interface.

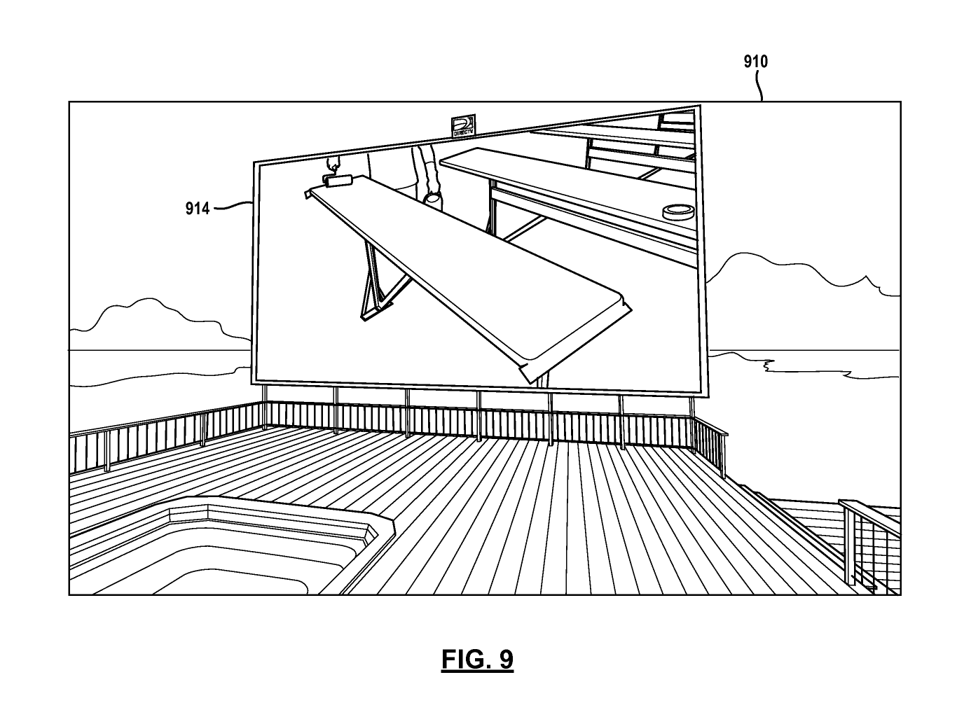

Referring now to FIG. 9, another screen display 910 of the virtual reality device is set forth having a television display area 914. The television display area 914 is relatively large compared to that of FIG. 8, and looks somewhat like a drive-in movie relative to the size of the other graphics objects in the screen display 910. The television display area 914 is on a relative perspective and is therefore slightly tapered. The scaling module 724 sizes and scales the live television signals to fit within the graphics of the video display therein.

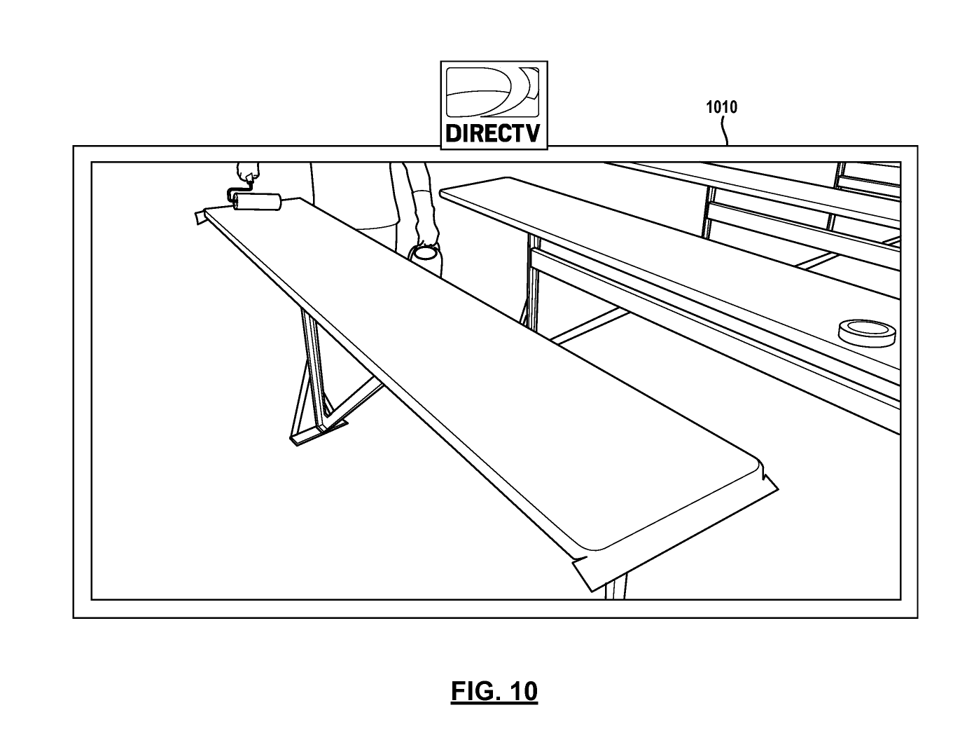

Referring now to FIG. 10, a screen display 1010 is illustrated so that the live or renderable signals are in a full screen mode. The screen display 1010 may be selected from a user interface or other type of controller or by swiping or touching a certain position on the virtual reality device 36. The screen display 1010 is enlarged to a greater size so that the entire display 42 illustrated in FIG. 5 of the virtual reality device has the live signal or renderable signal (or both) therein.

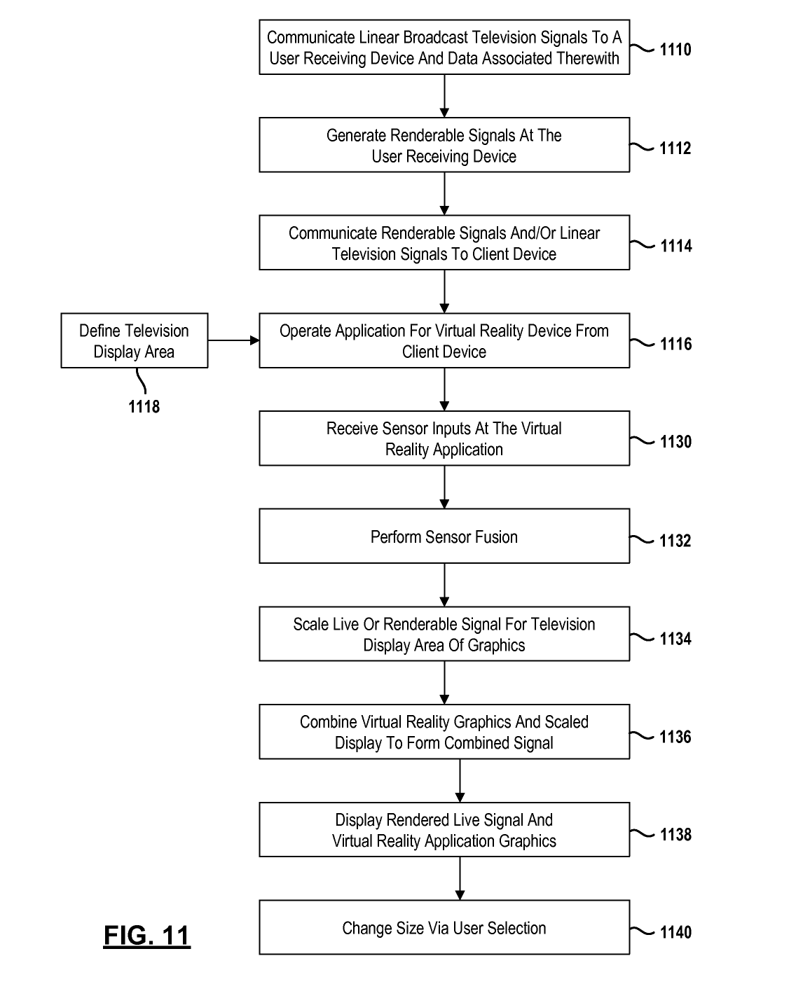

Referring now to FIG. 11, a method for controlling the display 42 of the virtual reality device 36 illustrated in FIG. 5 is set forth. In step 1110, linear or live broadcasted television signals are communicated to a user receiving device. The user receiving device may act as a server relative to a client device. In step 1112, renderable signals are generated at the user receiving device that corresponds to screen displays. In step 1114, the television signals and/or renderable signals are communicated to the client device.

In step 1116, an application for the virtual reality device is operated at the client device. It should be noted that a television display area is defined in step 1118. The live video area may be defined by a user or by a developer of the virtual reality system.

As the application operates the graphics are generated in the client device and displayed at the virtual reality device. In step 1130, the sensor inputs from the virtual reality device are received at the virtual reality application of the client device. In step 1132, sensor fusion is performed so that the relative position of the virtual reality device and any movement thereof is determined.

In step 1134, the renderable and linear video is scaled within the virtual reality application for the television display area within the graphics. Both the perspective and size of the television display area may be changed. The linear signal, the renderable signal or both may form a display signal. In step 1136, the virtual reality graphics and scale display signals are combined to form a combined signal. In step 1138, the combined signal is communicated so that it is displayed on the virtual reality device.

In step 1140, the system detects whether the user has selected to change the size of the television display of the graphics to a full screen virtual reality video display as shown in FIG. 10 or from a full size back to the size defined by the graphics. A change size signal may be received from a user interface selection signal from the user interface of either the virtual reality device or the client device to affect the changes.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method comprising:
communicating linear content signal to a user receiving device;
generating a renderable signal at the user receiving device;
communicating the linear content signal or the renderable signal to a client device to form a display signal;
defining a television display area for a graphics display of a virtual reality display device within a virtual reality application;
scaling the display signal to correspond to the television display area within the virtual reality application to form scaled content; and
displaying virtual reality graphics with the scaled display signal in the live content area.

2. The method as recited in claim 1 wherein communicating linear content to the user receiving device comprises communicating the linear content through as satellite.

3. The method as recited in claim 1 wherein communicating the linear content signal or the renderable signal comprises communicating the linear content or the renderable signal in an IP format to the client device.

4. The method as recited in claim 1 wherein communicating the linear content signal or the renderable signal comprises communicating the linear content or the renderable signal through a local area network and router to the client device.

5. The method as recited in claim 1 further comprising scaling the linear content signal or the renderable signal in response to a sensor fusion.

6. The method as recited in claim 1 wherein communicating the_linear content signal or the renderable signal to the client device comprises communicating the linear content signal or the renderable signal to a mobile phone.

7. The method as recited in claim 1 wherein communicating the linear content signal or the renderable signal to the client device comprises communicating the linear content signal or the renderable signal to a gaming system.

8. The method as recited in claim 1 further comprising switching the virtual reality device to a full screen mode and displaying the linear content signal or the renderable signal on a full virtual reality display.

9. The method as recited in claim 1 further comprising switching the virtual reality device to a full screen mode in response to a user interface selection and displaying the linear content signal or renderable signal on a full virtual reality display.

10. A system comprising:
a user receiving device receiving a linear content signal from a head end;
a client device in communication with the user receiving device;
said user receiving device generating a renderable signal and communicating the linear content signal or the renderable signal to the client device or a display signal;
said client device comprising a virtual reality application defining a television display area for a graphics display of a virtual reality display device;
said virtual reality application scaling the display signal to the television display area to scaled content; and
said virtual reality display device displaying virtual reality graphics with the scaled content in the television display area.

11. The system as recited in claim 10 further comprising a satellite communicating the linear content to the user receiving device.

12. The system as recited in claim 10 wherein the linear content signal or renderable signal is communicated in an IP format to the client device.

13. The system as recited in claim 10 further comprising a local area network communicating the linear content signal or renderable signal to the client device.

14. The system as recited in claim 10 wherein a sensor fusion module of the client device scales the display signal.

15. The system as recited in claim 10 wherein the client device comprises a mobile phone.

16. The system as recited in claim 10 wherein the client device comprises a gaming system.

17. The system as recited in claim 10 wherein the client device comprises a computer.

18. The system as recited in claim 10 wherein the virtual reality display device switches to a full screen mode and displaying the linear content or renderable signal on a full virtual reality display.

19. The system as recited in claim 10 further a user interface coupled to the client device for switching the virtual reality device to a full screen mode in response to a user interface selection.
